(19) United States
(12) Patent Application Publication
(10) Pub. No.: US 2024/0319572 A1
(43) Pub. Date: Sep. 26, 2024

(54) REMOTE PROJECTOR ALIGNMENT SYSTEM FOR SPHERICAL PROJECTION SYSTEM

(71) Applicants: John Marciniak, Upper Marlboro, MD (US); Jesse Marciniak, Cheltenham, MD (US)

(72) Inventors: John Marciniak, Upper Marlboro, MD (US); Jesse Marciniak, Cheltenham, MD (US)

(21) Appl. No.: 18/188,075

(22) Filed: Mar. 22, 2023

(51) Int. Cl. G03B 21/14; G03B 21/53

(52) U.S. Cl. CPC G03B 21/147; G03B 21/145; G03B 21/53; H04N 9/3147

(57) ABSTRACT

A remote alignment system in a spherical projector system includes a camera collocated with each projector to provide a live feed view of the surface of the spherical screen. The camera is electronically connected to the spherical projector system via Powered Over Ethernet connection injector cables. A client computer device running remote alignment software displays a graphical user interface that enables remote viewing of the projected images, manipulation of the camera, and manipulation of the projectors to remotely align of the spherical projector system. A method of remotely aligning the spherical projector system includes viewing the spherical screen remotely via live video camera feeds through remote access software; manipulating the projectors remotely via a remote alignment software interface to adjust focus, zoom, and/or orientation until alignment of the spherical projector system is achieved.

### BACKGROUND OF THE INVENTION

The present invention relates to a spherical projection system and, more particularly, to a remote projector alignment system therefor.

Science On a Sphere® is a spherical projection system that may include a sphere suspended from a ceiling or from the floor on a stand and surrounded by a plurality of projectors. The projectors may be mounted to the floor, wall, and/or the ceiling. Over the course of weeks or months, the projector images of the Science on a Sphere® become unaligned. If there is no one on-site to perform an alignment, the system's images will be misaligned. The alignment process is extremely technical. Currently, alignment must be performed on-site in person, utilizing an iPad application while walking around the sphere. The iPad must be connected to the Science on a Sphere® system and must be properly set up. It can be burdensome to require a technician's physical presence to align the projectors, especially during a museum or institution's open business hours. As can be seen, there is a need for a system that enables a skilled technician to login remotely at their convenience to perform alignments.

### SUMMARY OF THE INVENTION

In one aspect of the present invention, in a spherical projector system including a spherical screen, projectors operative to project images onto a surface of the spherical screen, a computer processor, coupled with a database, operative to obtain video content and transmit the video content to the projectors as well as to manipulate the projectors, a remote alignment system comprises a camera collocated with each of the projectors and configured to provide a live feed view of the surface of the spherical screen, the camera electronically connected to the spherical projector system by way of the computer processor via Powered Over Ethernet connection injector cables; and a client computer device running remote alignment software operative to display a graphical user interface that enables remote viewing of the projected images, manipulation of the camera, and manipulation of the projectors to enable remote alignment of the spherical projector system.

In another aspect of the present invention, a computer-implemented method of remotely aligning a spherical projector system comprises viewing a spherical screen remotely via a first live video camera feed through remote access software; manipulating a first projector remotely via a remote alignment software interface to adjust an image characteristic selected from the group consisting of: focus, zoom, orientation, and any combination thereof; viewing the spherical screen remotely iteratively via other live video camera feeds through the remote access software; and manipulating other projectors remotely iteratively via the remote alignment software interface to adjust the other projector image characteristics selected from the group consisting of: focus, zoom, orientation, and any combination thereof, until alignment of the spherical projector system is achieved.

In yet another aspect of the present invention, a non-transitory computer readable medium storing instructions that, when executed by a computer, cause the computer to implement a method of remotely aligning a spherical projector system comprises transmitting live video feed from a first camera collocated with a first projector of the spherical projector system to a remotely located user; receiving first alignment instructions from the remotely located user for the first projector; manipulating the first projector to adjust image characteristics selected from the group consisting of: focus, zoom, orientation, and any combination thereof, according to the first alignment instructions; transmitting live video feed iteratively from other cameras collocated with other projectors of the spherical projector system; receiving subsequent alignment instructions iteratively from the remotely located user for the other projectors; and manipulating the other projectors iteratively to adjust image characteristics selected from the group consisting of: focus, zoom, orientation, and any combination thereof, according to the subsequent alignment instructions until alignment is achieved.

This invention may be used to remotely control projector images (video content) on any installation or technology that relies on keeping a projector image aligned over a long period of time.

These and other features, aspects and advantages of the present invention will become better understood with reference to the following drawings, description, and claims.

### BRIEF DESCRIPTION OF THE DRAWINGS

FIG. 1 is a schematic front view of a remote projector alignment system according to an embodiment of the present invention;

FIG. 2 is a schematic top plan view thereof;

FIG. 3 is a side perspective view thereof;

FIG. 4 is a rear perspective view thereof; and

FIG. 5 is a flowchart of a method of remotely aligning a projector according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a mechanical and software system and method to control a Science on a Sphere® (spherical projector system) projector remotely to perform alignment. For example, the system may adjust the projector image focus, zoom, orientation, and any combination thereof.

The present invention enables a user to view the spherical screen via live video camera feed and remotely adjust the projected images using a software interface via a system computer (e.g., a desktop) having a computer processor with a non-transitory computer readable medium storing instructions, coupled with a database, operative to obtain video content and transmit the video content to the projectors.

Cameras placed in the room containing the Science on a Sphere® system provide a live feed view of the sphere. The cameras are spaced apart so that the camera view of the surface area of the sphere is equally apportioned. In some instances, each camera may be colocated with a projector. The cameras are connected to the Science on a Sphere® system using Powered Over Ethernet (POE) connection injector cables.

To produce the remote alignment system, the technician may assemble cameras that can connect to the Science on a Sphere® system. The technician may place the cameras so that they can view the projection sphere. The technician may also install remote alignment software onto the Science on a Sphere system that enables remote viewing of the projected images and control of the Science on a Sphere alignment process.

To use this invention, a technician may remotely log into their Science on a Sphere system's computer via remote access software. They launch the remote alignment software, activating a live view of one of the cameras at a time and its perspective with respect to the sphere. The user can use the remote alignment controller (4) to select different live views via various cameras and manipulate the projectors using the remote alignment software on a client computer device to adjust the projector images until alignment is achieved.

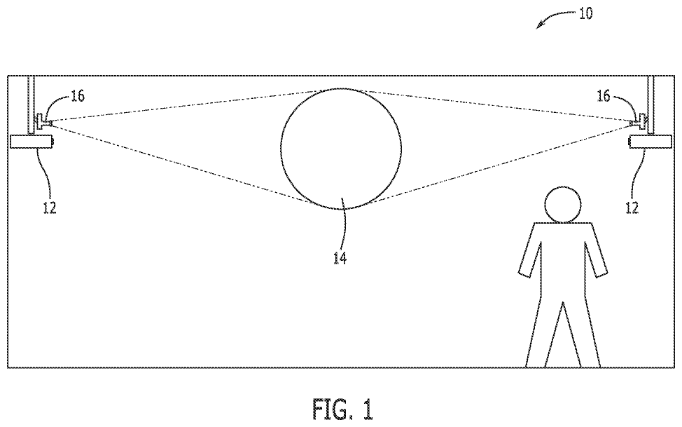

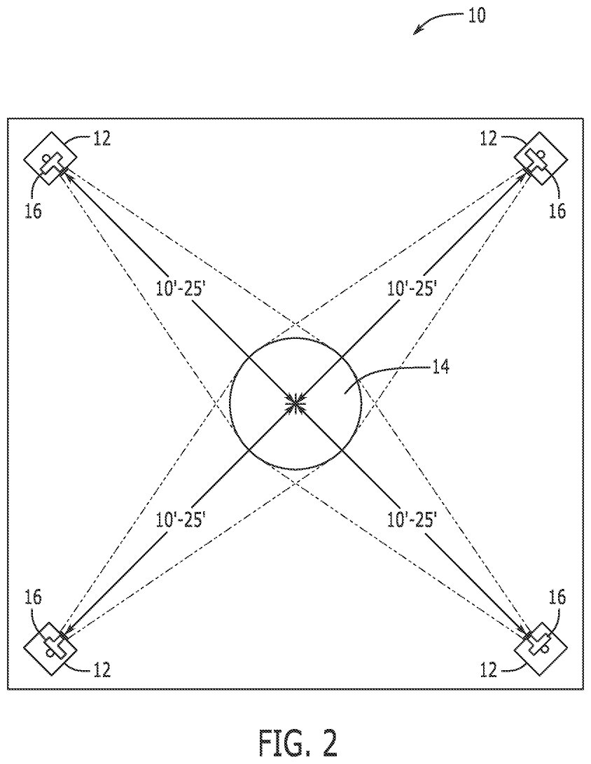

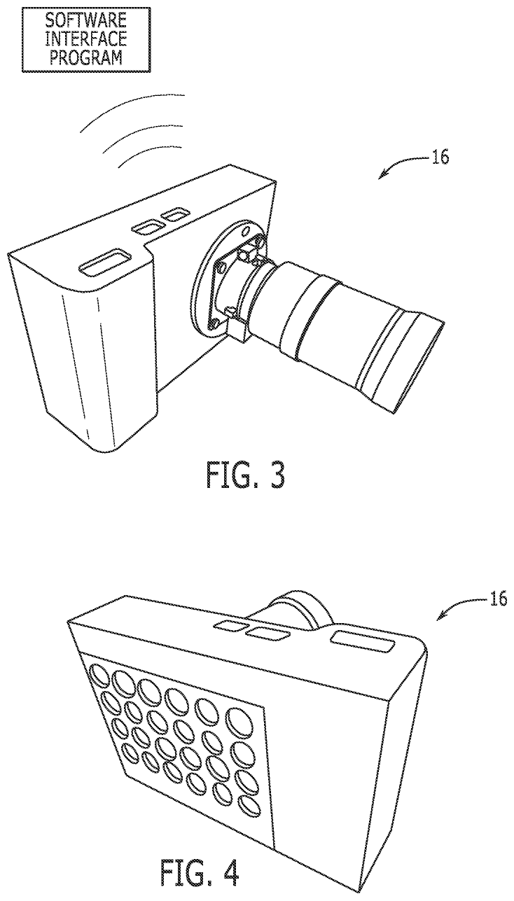

Referring to FIGS. 1 through 5, FIGS. 1 and 2 illustrate a Science on a Sphere® system having a remote projector alignment system 10, comprising projectors 12 projecting images onto a sphere 14 at a distance of about 10-25 feet. A camera 16 co-located with each projector 12 enables a technician to observe the position of images on the sphere 14. As shown in FIGS. 3 and 4, the cameras 16 transmit video to a software interface program that also enables adjustment of each projector 12. The technician adjusts each projector 12 iteratively while observing alignment on the sphere with the associated camera 16 until all of the projectors 12 are aligned.

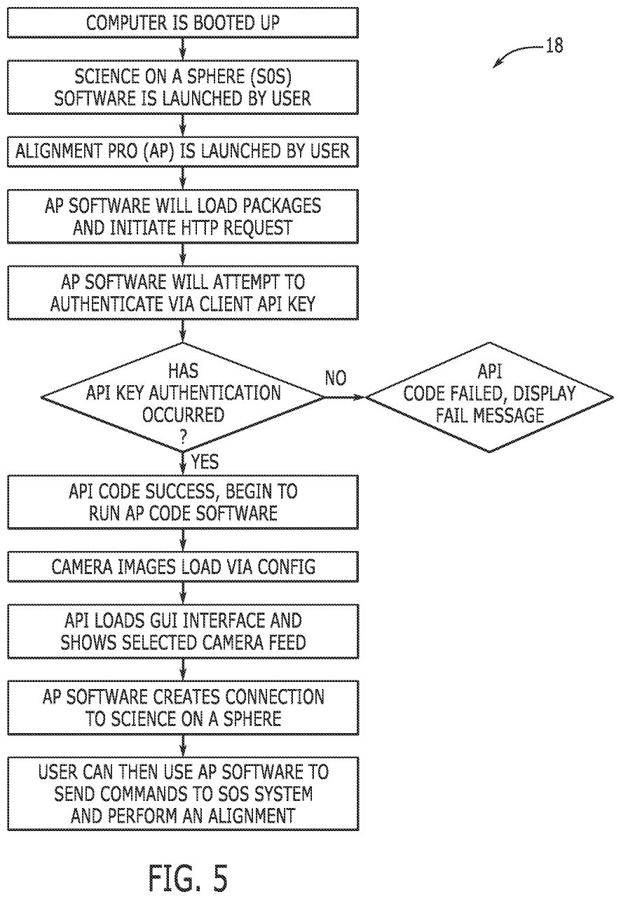

The software interface program may implement a method comprising steps shown in a flowchart 18 in FIG. 5. Once the computer is booted up, the Science on a Sphere® (SOS) software and alignment software (referred to sometimes herein as Alignment Pro [AP]) may be launched by the user. The alignment software loads packages, initiates a Hypertext Transfer Protocol (HTTP) request, and attempts authentication view a client application programming interface (API) key. If authentication is unsuccessful, the system returns an error message. If authentication is successful, the alignment software runs alignment code. The camera images load via CONFIG, API loads a graphical user interface (GUI), displays a selected camera feed, and connects to the Science on a Sphere® projector system. The user may send commands to the projectors to perform an alignment while viewing the results over the camera feed.

It should be understood, of course, that the foregoing relates to exemplary embodiments of the invention and that modifications may be made without departing from the spirit and scope of the invention as set forth in the following claims.

What is claimed is:

1. In a spherical projector system including a spherical screen, projectors operative to project images onto a surface of the spherical screen, a computer processor, coupled with a database, operative to obtain video content and transmit the video content to the projectors as well as to manipulate the projectors, a remote alignment system comprising:
a camera collocated with each of the projectors and configured to provide a live feed view of the surface of the spherical screen, the camera electronically connected to the spherical projector system by way of the computer processor via Powered Over Ethernet connection injector cables;
and a client computer device running remote alignment software operative to display a graphical user interface that enables remote viewing of the projected images, manipulation of the camera, and manipulation of the projectors to enable remote alignment of the spherical projector system.

2. A computer-implemented method of remotely aligning a spherical projector system, comprising:
viewing a spherical screen remotely via a first live video camera feed through remote access software;
manipulating a first projector remotely via a remote alignment software interface to adjust an image characteristic selected from the group consisting of: focus, zoom, orientation, and any combination thereof;
viewing the spherical screen remotely iteratively via other live video camera feeds through the remote access software; and
manipulating other projectors remotely iteratively via the remote alignment software interface to adjust the other projector image characteristics selected from the group consisting of: focus, zoom, orientation, and any combination thereof, until alignment of the spherical projector system is achieved.

3. A non-transitory computer readable medium storing instructions that, when executed by a computer, cause the computer to implement a method of remotely aligning a spherical projector system, comprising:
transmitting live video feed from a first camera collocated with a first projector of the spherical projector system to a remotely located user;
receiving first alignment instructions from the remotely located user for the first projector;
manipulating the first projector to adjust image characteristics selected from the group consisting of: focus, zoom, orientation, and any combination thereof, according to the first alignment instructions;
transmitting live video feed iteratively from other cameras colocated with other projectors of the spherical projector system;
receiving subsequent alignment instructions iteratively from the remotely located user for the other projectors; and
manipulating the other projectors iteratively to adjust image characteristics selected from the group consisting of: focus, zoom, orientation, and any combination thereof, according to the subsequent alignment instructions until alignment is achieved.
